(19) United States
(12) Patent Application Publication
(10) Pub. No.: US 2005/0167252 A1
(43) Pub. Date: Aug. 4, 2005

(54) Steering wheel incorporating user-friendly switches

(75) Inventors: Takefumi Inoue, Nara (JP); Takatoshi Ono, Kyoto (JP); Kazuji Ohta, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/038,062

(22) Filed: Jan. 21, 2005

(30) Foreign Application Priority Data
Feb. 4, 2004 (JP) 2004-027641

(51) Int. Cl. H01H 9/00

(52) U.S. Cl. 200/61.54

(57) ABSTRACT

The operating force and position of a front side switch and back side press button switches are determined according to the properties of the force and length of the thumb and the other fingers of a driver. The front side switch is disposed on the front side of the spoke of a steering wheel. The back side press button switches are disposed on the back side thereof. This structure improves operability of the front side switch and back side press button switches mounted on the steering wheel.

### BACKGROUND OF THE INVENTION

1. Field of the Invention

The present invention relates to a steering wheel disposed in a vehicle and the like for steering thereof.

2. Background Art

Recent years, increases in the number of the functions of a vehicle, the number of on-vehicle devices and their functions increase the number of switches in the vehicle. For this reason, switches to be manipulated during driving are mounted even on the front side of a steering wheel for running control.

A conventional steering wheel incorporating such switches is described with reference to FIGS. 11 through 14. FIG. 11 is a side elevation view of a conventional steering wheel. FIG. 12 is a front view thereof.

With reference to FIGS. 11 and 12, steering wheel 1 has spoke 1B inside of circular ring-shaped steering rim 1A. Disposed on the front side of spoke 1B faced with a driver is a plurality of press button switches 2. For simplicity, the number of the press button switches is three in the drawing.

The manipulation part of each press button switch 2 is different and shaped so that a driver can easily feel for. Switching operation can be performed by pressing the manipulation part of each press button switch 2. Used for each press button switch 2 is a general-purpose material capable of providing positive tactile response of depressing when the switch is depressed with a thumb.

Control signals generated by the operation of these press button switches 2 are transferred to the side of a vehicle via a spiral cable (not shown) installed for detection of the action of steering wheel 1. Then, responsive to the control signals, each on-vehicle device is controlled.

The above-mentioned is a steering wheel incorporating push button switches 2 only on the front side of steering rim 1A. For another conventional steering wheel, FIG. 13 shows a side view thereof and FIG. 14 shows a rear view thereof. Steering wheel 4 having spoke 4B inside of circular ring-shaped steering rim 4A has press button switches 3 on the back side of spoke 4B.

As the prior art references of the conventional steering wheels, Japanese Patent Unexamined Publication No. 2003-175783 and Japanese Utility Model Unexamined Publication No. 3068141 are known.

Conventional steering wheel 1 has each press button switch 2 on the front side of spoke 1B and conventional steering wheel 4 has each press button switch 3 on the back side of spoke 4B. Thus, it is easy to combine both structures to mount each press button switches on the front and back sides of a steering wheel. However, when the number of push button switches to be mounted increases, manipulation is more complicated and maintaining user-friendliness of each press button is difficult. Further, wrong manipulation of the many push button switches often occurs.

### SUMMARY OF THE INVENTION

The present invention addresses these problems and aims to provide a steering wheel that has user-friendly switches disposed on the front and back sides of the steering wheel and can prevent wrong manipulation of the switches.

To attain the above objective, the present invention provides a steering wheel that has a front side switch on the front side of a steering rim faced with a driver, and back side press button switches on the back side thereof. The front side switch is made of press button switches. The force required to operate the front side press button switches is different from the force required to operate the back side press button switches.

With this structure, the depressing force and position of the front side switch and back side press button switches can be set according to the properties of the force and length of the thumb and the other fingers. This feature provides the following useful advantages: each switch disposed in the steering wheel is user-friendly, and wrong manipulation of the switches can be prevented, using the state of back side press button switches.

### BRIEF DESCRIPTION OF THE DRAWINGS

FIG. 1 is a side elevation view of a steering wheel in accordance with a first exemplary embodiment of the present invention.

FIG. 2 is a front view of the steering wheel in accordance with the first exemplary embodiment.

FIG. 3 is a rear view of the steering wheel in accordance with the first exemplary embodiment.

FIG. 4 is a top view of the steering wheel in accordance with the first exemplary embodiment.

FIG. 5 is a graph showing feeling curves of a front side press button switch and a back side press button switch, i.e. essential parts of the steering wheel in accordance with the first exemplary embodiment.

FIG. 6 is a top view of a steering wheel in which the back side press button switches in the steering wheel of the first exemplary embodiment are displaced nearer to a rotation center of the steering wheel than the front press button switches.

FIG. 7 is a front view of a steering wheel in accordance with a second exemplary embodiment of the present invention.

FIG. 8 is a side elevation view of the steering wheel in accordance with the second exemplary embodiment.

FIG. 9 is a front view of a steering wheel in accordance with a third exemplary embodiment of the present invention.

FIG. 10 is a side elevation view of the steering wheel in accordance with the third exemplary embodiment.

FIG. 11 is a side elevation view of a conventional steering wheel.

FIG. 12 is a front view of the conventional steering wheel.

FIG. 13 is a side elevation view of a conventional steering wheel of another structure.

FIG. 14 is a rear view of the conventional steering wheel of another structure.

### DETAILED DESCRIPTION OF THE INVENTION

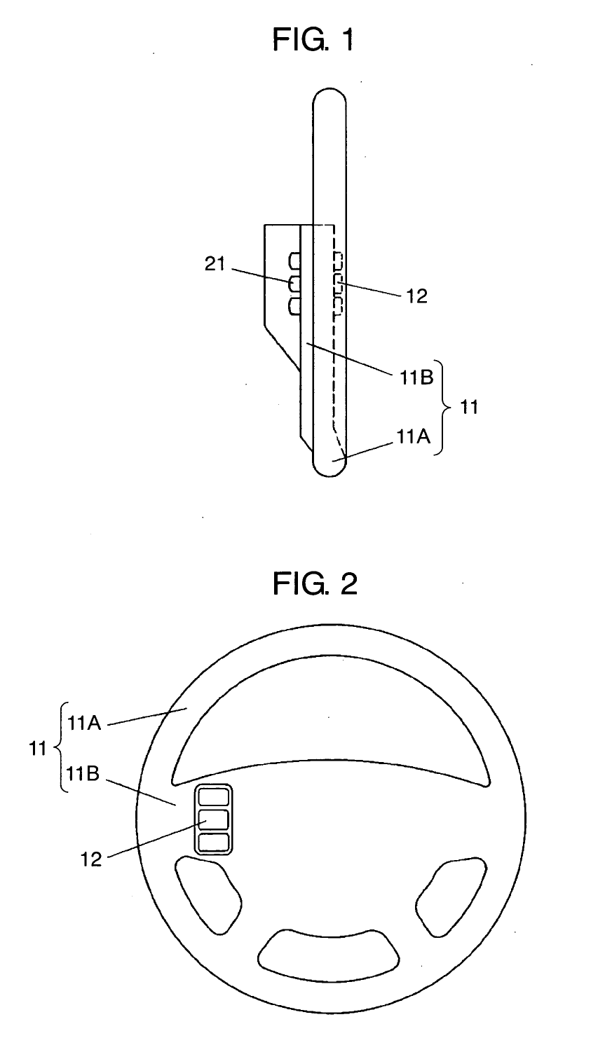

Exemplary embodiments of the present invention are described hereinafter with reference to FIGS. 1 through 10.

### FIRST EMBODIMENT

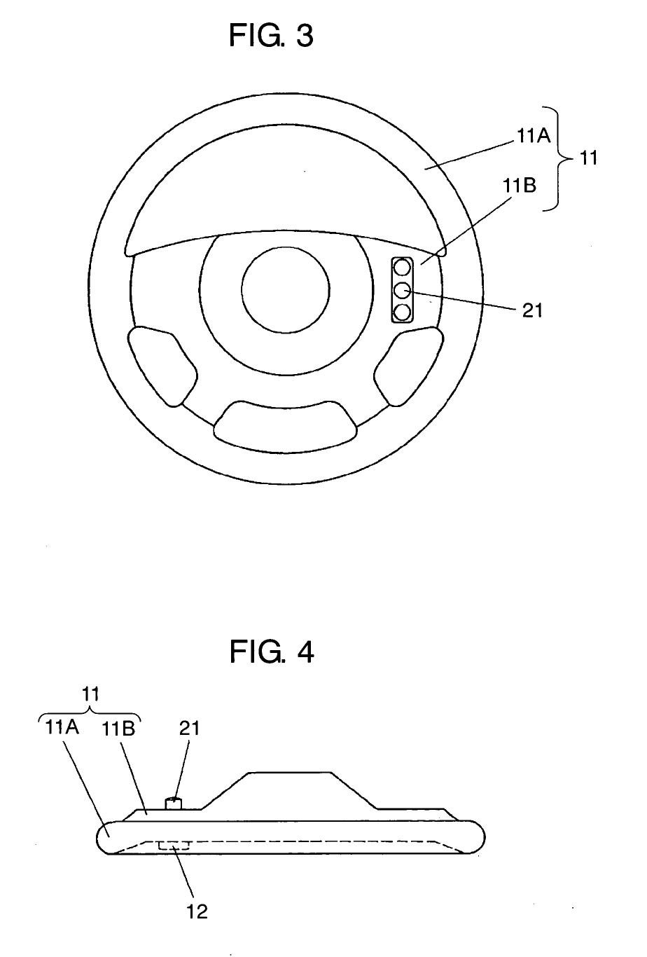

FIG. 1 is a side elevation view of a steering wheel in accordance with the first exemplary embodiment of the present invention. FIG. 2 is a front view thereof. FIG. 3 is a rear view thereof. FIG. 4 is a top view thereof.

With reference to FIGS. 1 through 4, steering wheel 11 has spoke 11B inside of circular ring-shaped steering rim 11A. On the front side of spoke 11A faced with a driver, three front side press button switches 12 are disposed in juxtaposition. Each of front side press button switches 12 may be a general-purpose press button switch capable of providing positive tactile response of depressing when the switch is depressed with the thumb. The number of front side press button switches 12 to be disposed is not limited to three, and a required number of switches can be provided. Preferably, the surface of the press button in each of front side press button switches 12 is shaped so that a driver can easily feel for, though not shown.

Also on the back side of this spoke 11, three back side press button switches 21 are disposed. The number of back side press button switches 21 to be disposed is not limited to three, and a required number of switches can be provided. The manipulation part of each press button switch is shaped so that a driver can easily feel for. Switching operation can be performed by depressing the manipulation part of each of these press buttons. Back side press button switches 21 are made of a material capable of providing positive tactile response of depressing when the switch is depressed with a finger.

Further, front side press button switches 12 and back side press button switches 21 are disposed so that they can be depressed perpendicular to the side of steering rim 11A faced with a driver. Also, front side press button switches 12 are disposed on the front side and back side press button switches 21 are disposed on the back side of spoke 11B faced with the driver so that the front and back side press button switches are opposite to each other.

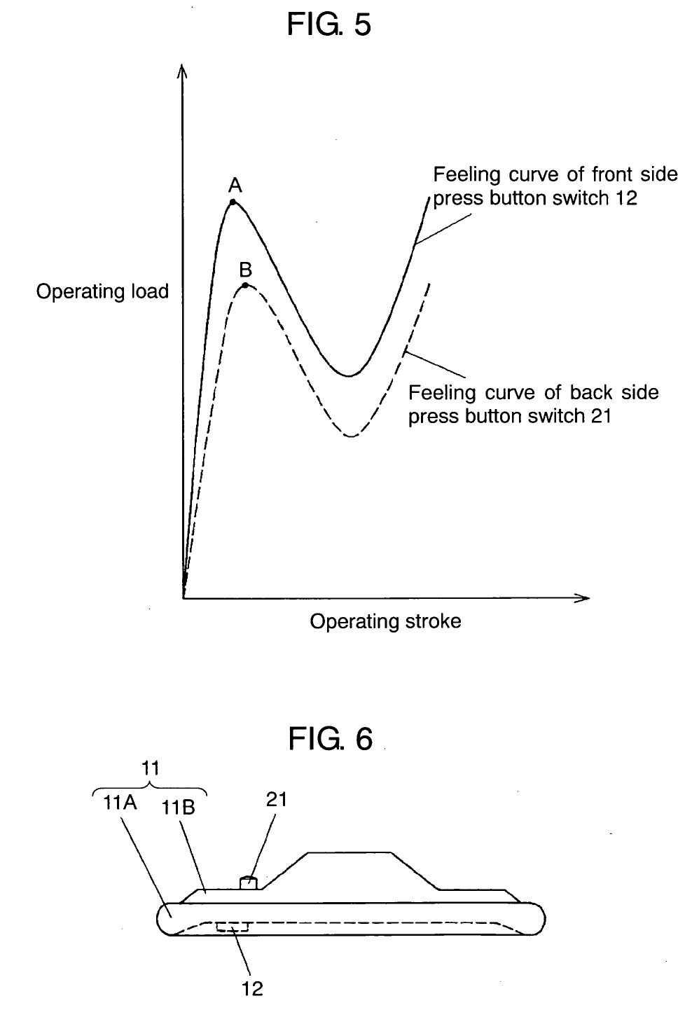

Next, a brief description is provided of how to set the magnitude of operating force of front side press button switches 12 and back side press button switches 21, using the feeling curve of each switch shown in FIG. 5.

In FIG. 5, the X-axis shows an operating stroke, and the Y-axis shows operating load. The feeling curve of front side press button switch 12 is shown in a solid line, and the feeling curve of back side press button switch 21 is shown in a broken line. FIG. 5 shows that peak load B for operating back side press button switch 21 is smaller than peak load A for operating front side press button switch 12.

Next, the operating state of front side press button switches 12 and back side press button switches 21 provided in the steering wheel of the first exemplary embodiment of the present invention is described.

First, a driver slides his/her hand along the outer periphery of steering rim 11A from a state of griping steering rim 11A to a state of touching spoke 11B with his/her thumb. After the driver has slid the hand along the outer periphery of steering rim 11A, the thumb is naturally positioned on the front side of spoke 11B faced with the driver, and his/her fingers other than the thumb on the back side thereof. In other words, in that state, the driver can depress front side press button switches 12 with the thumb and/or back side press button switches 21 with the fingers other than the thumb.

Because front side press button switches 12 are disposed on the front side of spoke 11B faced with the driver and back side press button switches 21 are disposed on the back side thereof opposite to each other in this state, the positions of front side press button switches 12 and back side press button switches 21 are easily touched by the driver.

Further, the driver depresses desired ones of front side press button switches 12 and/or back side press button switches 21 in the direction orthogonal to the front side of spoke 11B faced with the driver with the corresponding fingers.

At this time, as shown in FIG. 5, back side press button switches 21 need operating force smaller than that of front side press button switches 12. For this reason, back side press button switches 21 can properly be depressed with any of the relatively weak fingers from the index finger to the little finger, compared with thumb.

When any one of front side press button switches 12 and/or back side press button switches 21 is depressed and its state is changed, a control signal generated by the changeover is transferred to a control section on the side of the vehicle via a spiral cable (not shown) installed in steering wheel 11 for various kinds of control of the on-vehicle devices.

When back side press button switches 21 are slightly displaced nearer to the rotation center of steering wheel 11 than front side press button switches 12, as shown in the top view of FIG. 6, operability can further be improved. In other words, in such a configuration, when a driver slides his/her hand along the outer periphery of steering rim 11A from a state of griping steering rim 11A to a state of touching spoke 11B with his/her fingers, the driver can easily touch back side press button switches 21 with the fingers other than the thumb only by the sliding operation of the hand. This is because the fingers other than the thumb are nearer to the rotation center when the driver slides the hand. Further, because back side press button switches 21 can be operated with operating force smaller than that of front press button switches 12, proper depressing operation can be maintained even when the fingers other than the thumb from the index finger to the little finger are slightly stretched.

Such a configuration is especially useful when a plurality of back side press button switches 21 is disposed. In other words, because the lengths of fingers are different from the index finger to the little finger, when back side press button switches 21 corresponding to the respective fingers are displaced toward the rotation center of steering wheel 11 separately, depressing operation in more natural state can be performed. Further, when back side press button switches 21 operable with different operating forces corresponding to respective fingers from the index finger to the little finger are disposed in positions corresponding to the respective fingers, operability can further be improved.

For any configuration as described above, front side press button switches 12 and back side press button switches 21 can be operated separately in a user-friendly manner. Additionally, a steering wheel can be structured so that these switches can also serve to prevent wrong operation of the switches.

In other words, when one or more back side press button switches 21 are kept in the ON state, operation of front press button switch 12 can control an intended device. Now, “ON state” means the operation of back side press button switches 21 has brought the steering wheel into a state in which various kinds of control can be performed on the on-vehicle devices.

In such a structure, when the one or more back side press button switches are not in the ON state, the on-vehicle devices cannot operate. Thus, even when a driver's elbow or the like inadvertently hits the front side press button switches 12, the corresponding devices do not operate. Therefore, wrong operation of the devices can be prevented. Also at this time, front side press button switches 12 and back side press button switches 21 are disposed to be opposite to each other. The operating force of back side press button switches 21 is smaller than that of front side press button switches 12. Therefore, depressing operation of the back side press button switches 21 can properly be kept with the weak fingers other than the thumb. Front press button switches 12 can easily and freely be operated with the thumb. Incidentally, it can also be structured that operation of front side press button switches 12 brings the steering wheel into “ON state” in which various kinds of control can be performed. However, because the thumb can perform more complicated manipulation than the other fingers and is placed on the visible front side, controlling the on-vehicle devices by the operation of front side button switches 12 is preferable.

### SECOND EMBODIMENT

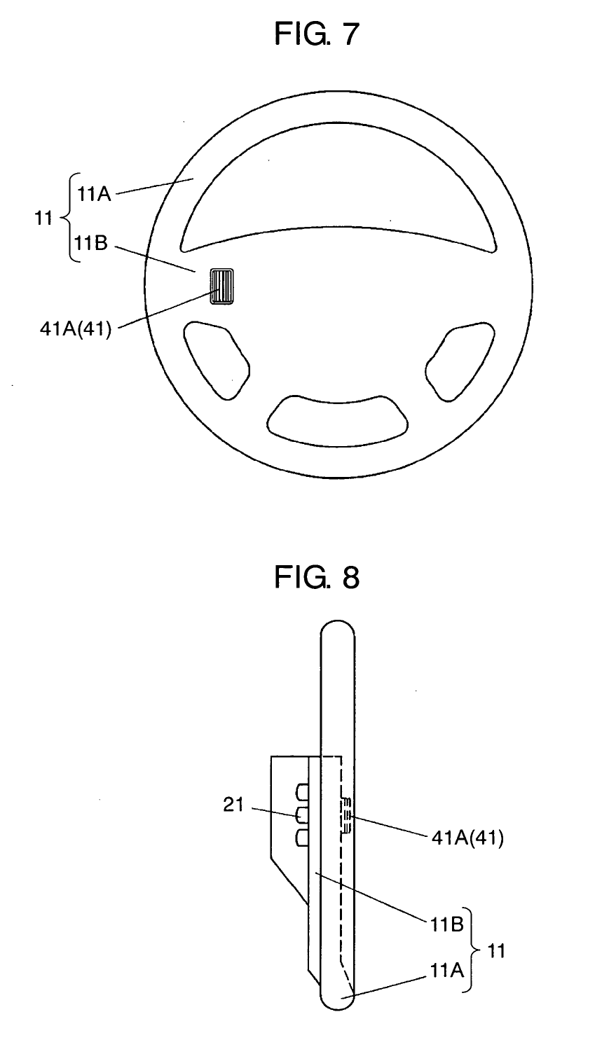

FIG. 7 is a front view of a steering wheel of the second exemplary embodiment of the present invention. FIG. 8 is a side elevation view thereof. Same elements used in the steering wheel of the first embodiment are denoted with the same reference marks and detailed description thereof is omitted.

As shown in FIGS. 7 and 8, the steering wheel of the second embodiment is different from the steering wheel of the first embodiment in that front side switch 41 disposed on the front side of spoke 11B inside of steering rim 11A is a rotary switch. On the back side of spoke 11B having front side switch 41, back side press button switches 21 are disposed in a position opposite to front side switch 41. Back side press button switches 21 are properly operable with small operating force of the fingers other than the thumb of a driver.

Front side switch 41 has a roller-shaped rotary knob 41A of which outer peripheral surface is rotated with the thumb, as a switch manipulation part. Rotary knob 41A is disposed so that the top portion of its outer peripheral surface protrudes from the front side of spoke 11B by a predetermined amount. The rotation axis of rotary knob 41A at rotation is substantially orthogonal to the radial direction of steering rim 11A. Front side switches 41 include a rotary switch capable of changing over the state according to the rotation of rotary knob 41A, and a rotary encoder for providing encoder signals by continuous rotating operation.

When rotary knob 41A is disposed in the above-mentioned positional relation, sliding operation of the hand of a driver onto spoke 11B along steering rim 11A allows his/her thumb positioned on the front side to be moved in the radial direction of steering rim 11A easily. Therefore, the thumb can repeatedly and continuously rotate rotary knob 41A, so the operability of rotary knob 41 is improved.

Additionally, the thumb slid on spoke 11B in this manner can easily be moved in the direction orthogonal to the radial direction of steering rim 11A. For this reason, the rotation axis of rotary knob 41A can also be disposed in the radial direction of steering rim 11A. Alternatively, front side switch 41 can be structured so that depressing rotary knob 41A provides switching signals. Further, the shapes of rotary knob 41A include those other than the roller shape, such as a disk shape, and an arc shape in section. Specifically, rotary knob 41A of a disk shape is disposed in spoke 11B, and the top surface of the disk can be rotated with the thumb.

Further, a steering wheel can be structured so that when one or more back side press button switches 21 are kept in the ON state, operation of front side switch 41 can control an intended device.

### THIRD EXMBODIMENT

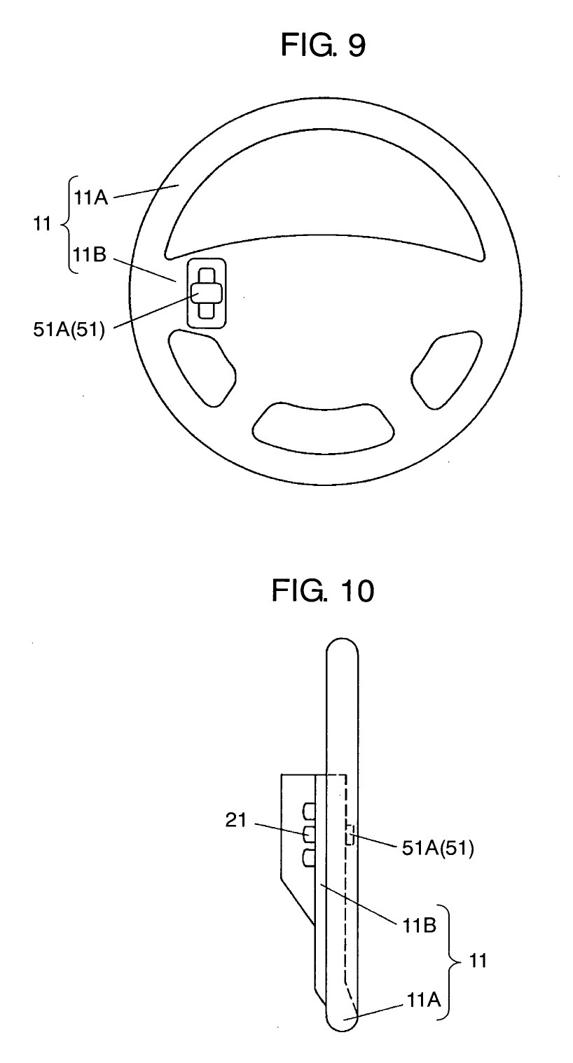

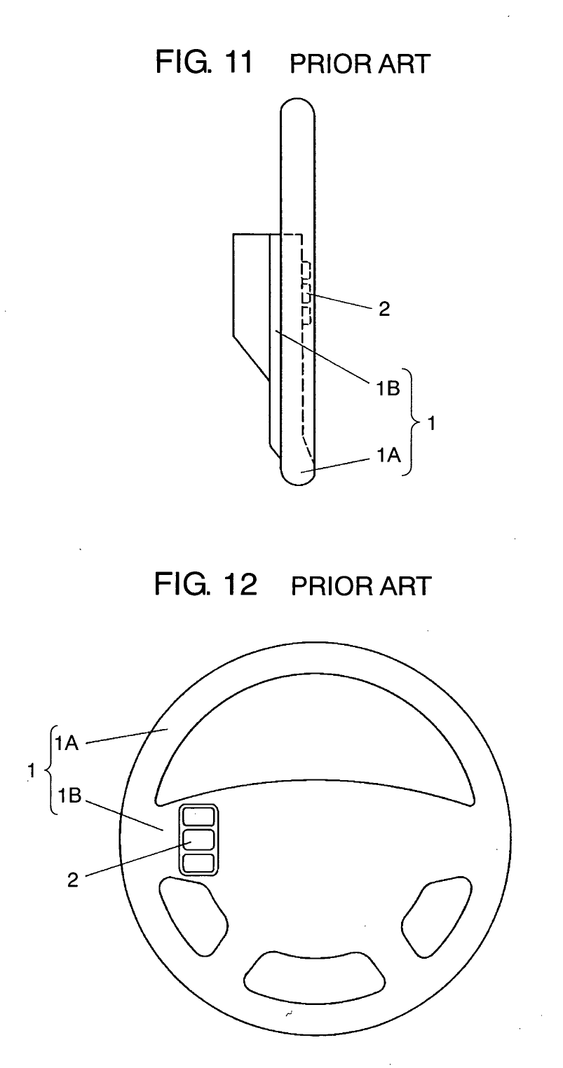

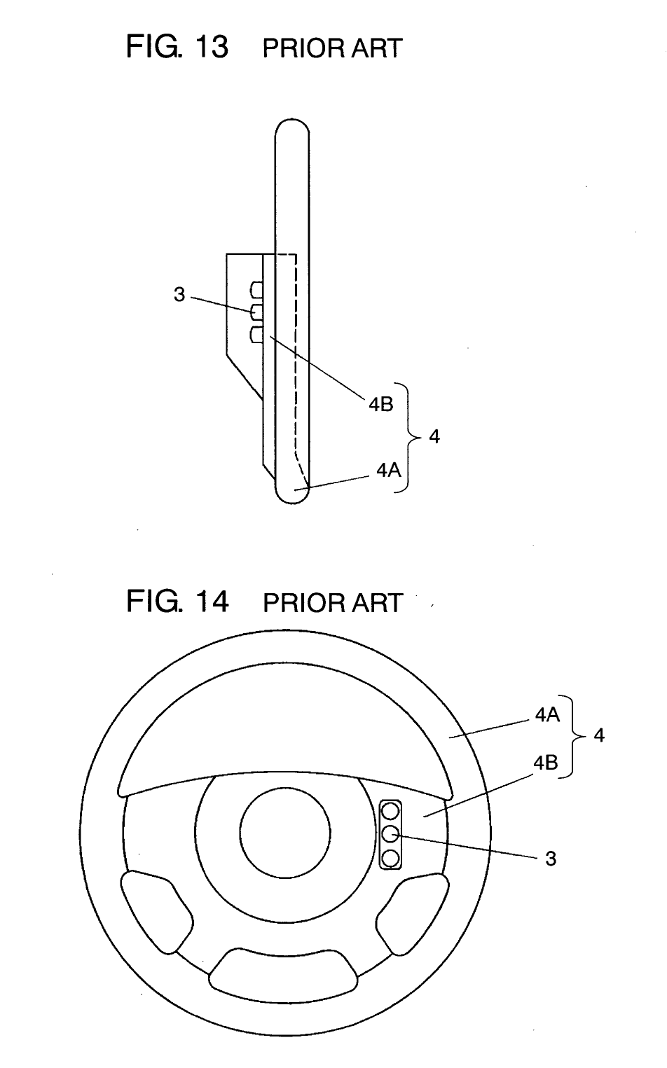

FIG. 9 is a front view of a steering wheel of the third exemplary embodiment of the present invention. FIG. 10 is a side elevation view thereof. Same elements used in the steering wheel of the first embodiment are denoted with the same reference marks and detailed description thereof is omitted.

As shown in FIGS. 9 and 10, the steering wheel of the third embodiment is different from the steering wheel of the first embodiment in that front side switch 51 disposed on the front side of spoke 11B inside of steering rim 11A is a slide switch. On the back side of spoke 11B having front side switch 51, back side press button switches 21 are disposed in a position opposite to front side switch 51. Back side press button switches 21 are properly operable with small operating force of the fingers other than the thumb of a driver.

Front side switch 51 is disposed so that the sliding direction of the slide switch in switch manipulation part 51A is orthogonal to the radial direction of steering rim 11A. This configuration improves the operability of switch manipulation part 51A. Alternatively, front side switch 51 can be disposed so that the radial direction of steering rim 11A is the same as the sliding direction of the slide switch in switch manipulation part 51A. Additionally, front side switch 51 having cross-shaped switch manipulation part 51A can be disposed so that the switch can be slid both in the radial direction of steering rim 11A and in the direction orthogonal thereof.

Further, a steering wheel can be structured so that when one or more back side press button switches 21 are kept in the ON state, operation of front side switch 51 can control an intended device.

A steering wheel that has each switch disposed in the steering wheel other than the spoke according to the above-mentioned ideas is included in the scope of the present invention.

As described above, in a steering wheel of the present invention, the depressing force and position of the front side switch and back side press button switches are determined according to the properties of the force and length of the thumb and other fingers of a driver. Thus, the operability of the front side switch and back side press button switches disposed in the steering wheel is improved. Further, wrong operation of the switches is prevented using the state of the back side press button switches. Therefore, the practical advantages of the present invention are great.

1. A steering wheel comprising:
a circular ring-shaped steering rim;
a spoke supporting the steering rim;
a front side switch provided on a front side of the spoke faced with a driver; and
a back side press button switch provided on a back side of the spoke;
wherein the front side switch is a press button switch; and
force required to operate the front side switch is different from force required to operate the back side press button switch.

2. The steering wheel of claim 1, wherein the force required to operate the back side press button switch is smaller than the force required to operate the front side switch.

3. The steering wheel of claim 1, wherein the front side switch is disposed on the front side of the spoke and the back side press button switch is disposed on the back side thereof oppositely.

4. The steering wheel of claim 1, wherein the back side press button switch is disposed nearer to a rotation center of the steering rim than the front side switch.

5. The steering wheel of claim 1, wherein a plurality of back side press button switches is provided and the force required to operate the respective back side press button switches are different.

6. The steering wheel of claim 2, wherein, when the back side press button switch is operated to bring the steering wheel into a state in which an intended device can be controlled, operation of the front side switch can control the intended device.

7. The steering wheel of claim 1, wherein the front side switch is a rotary switch.

8. The steering wheel of claim 1, wherein the front side switch is a slide switch.
